(19) United States
(12) Patent Application Publication
(10) Pub. No.: US 2025/0356594 A1
(43) Pub. Date: Nov. 20, 2025

(54) METHOD AND APPARATUS WITH 3D OCCUPANCY PREDICTION LEARNING

(71) Applicants: Samsung Electronics Co., Ltd., Suwon-si (KR); Korea University Research and Business Foundation, Seoul (KR)

(72) Inventors: Sujin JANG, Suwon-si (KR); Sangpil KIM, Seoul (KR); Sungjune KIM, Seoul (KR); Jinkyu KIM, Seoul (KR); Gyeong Rok OH, Seoul (KR); Dongwook LEE, Suwon-si (KR); Dae Hyun JI, Suwon-si (KR)

(73) Assignees: Samsung Electronics Co., Ltd., Suwon-si (KR); Korea University Research and Business Foundation, Seoul (KR)

(21) Appl. No.: 18/972,088

(22) Filed: Dec. 6, 2024

(30) Foreign Application Priority Data
May 16, 2024 (KR) 10-2024-0064039
Jul. 26, 2024 (KR) 10-2024-0099605

(51) Int. Cl. G06T 19/00; G06T 7/10; G06T 9/00; G06V 10/44; G06V 10/762

(52) U.S. Cl. CPC G06T 19/00; G06T 7/10; G06T 9/001; G06V 10/44; G06V 10/762; G06T 2207/20081

(57) ABSTRACT

A processor-implemented method with three-dimensional (3D) occupancy prediction learning includes extracting multi-scale image feature vectors from received two-dimensional (2D) image data, generating a local cluster feature vector by clustering the extracted multi-scale image feature vectors, mapping the local cluster feature vector to a 3D space through an attention operation using a learnable voxel query; decoding a 3D voxel query generated according to the mapping result, and predicting a 3D occupancy state and a semantic class for a space, based on the decoding result.

### CROSS-REFERENCE TO RELATED APPLICATIONS

This application claims the benefit under 35 USC § 119 (a) of Korean Patent Application No. 10-2024-0064039, filed on May 16, 2024 and Korean Patent Application No. 10-2024-0099605, filed on Jul. 26, 2024, in the Korean Intellectual Property Office, the entire disclosures of which are incorporated herein by reference for all purposes.

### BACKGROUND

### 1. Field

The following description relates to a method and apparatus with three-dimensional (3D) occupancy prediction learning.

### 2. Description of Related Art

Spatial awareness and environmental understanding are essential in autonomous vehicles, drones, and robots. For this purpose, technology that converts two-dimensional image data into three-dimensional information and predicts a space occupancy state is important. 3D occupancy prediction technology may enable an autonomous vehicle to accurately understand the road and surrounding environments and to detect obstacles for safe driving. Typical techniques may cause information loss in the process of converting two-dimensional (2D) image data into 3D space, and when high-resolution queries are used, computational complexity increases in the typical techniques, making real-time processing difficult. Typical techniques may also result in low prediction accuracy because they only use low-level features of 2D images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with three-dimensional (3D) occupancy prediction learning includes extracting multi-scale image feature vectors from received two-dimensional (2D) image data, generating a local cluster feature vector by clustering the extracted multi-scale image feature vectors, mapping the local cluster feature vector to a 3D space through an attention operation using a learnable voxel query, decoding a 3D voxel query generated according to the mapping result, and predicting a 3D occupancy state and a semantic class for a space, based on the decoding result.

The attention operation may reflect clustered information in the learnable voxel query by performing aggregate and dispatch.

The method may include training networks for 3D occupancy prediction learning by using the 3D voxel query in 2D image segmentation supervised learning.

The training of the networks may include obtaining an encoded 3D voxel query from the 3D voxel query and the extracted multi-scale image feature vectors, and outputting an attention segmentation map based on a deformable attention map derived from the encoded 3D voxel query.

The method may include performing contrastive learning using the attention segmentation map and a pseudo mask.

The decoding of the 3D voxel query may include performing voxel upsampling of the 3D voxel query by reflecting permutation invariance of a 3D space.

The performing of the voxel upsampling may include generating augmented 3D voxel queries by transforming the 3D voxel query into a plurality of viewpoints.

The method may include applying a consistency regularization technique via a transposed convolutional network to the augmented 3D voxel queries.

The 2D image data may include image data obtained from a multi-view camera.

In one or more general aspects, a non-transitory computer-readable storage medium may store instructions that, when executed by one or more processors, configure the one or more processors to perform any one, any combination, or all of operations and/or methods disclosed herein.

In one or more general aspects, an electronic device includes one or more processors configured to extract multi-scale image feature vectors from received two-dimensional (2D) image data, generate a local cluster feature vector by clustering the extracted multi-scale image feature vectors, map the local cluster feature vector to a three-dimensional (3D) space through an attention operation using a learnable voxel query, decode a 3D voxel query generated according to the mapping result, and predict a 3D occupancy state and a semantic class for a space, based on the decoding result.

The attention operation may reflect clustered information in the learnable voxel query by performing aggregate and dispatch.

The one or more processors may be configured to train networks for 3D occupancy prediction learning by using the 3D voxel query in 2D image segmentation supervised learning.

For the training of the networks, the one or more processors may be configured to obtain an encoded 3D voxel query from the 3D voxel query and the extracted multi-scale image feature vectors, and output an attention segmentation map based on a deformable attention map derived from the encoded 3D voxel query.

The one or more processors may be configured to perform contrastive learning using the attention segmentation map and a pseudo mask.

For the decoding of the 3D voxel query, the one or more processors may be configured to perform voxel upsampling of the 3D voxel query by reflecting permutation invariance of a 3D space.

For the performing of the voxel upsampling, the one or more processors may be configured to generate augmented 3D voxel queries by transforming the 3D voxel query into a plurality of viewpoints.

The one or more processors may be configured to apply a consistency regularization technique via a transposed convolutional network to the augmented 3D voxel queries.

The 2D image data may include image data obtained from a multi-view camera.

In one or more general aspects, a vehicle includes one or more processors configured to drive a three-dimensional (3D) voxel query decoder trained in a 3D occupancy prediction learning process, and drive a 3D voxel decoder configured to predict a 3D occupancy state and a semantic class for a space from a two-dimensional (2D) image received from a camera included in the vehicle, wherein the training of the 3D voxel query decoder in the 3D occupancy prediction learning process may include extracting multi-scale image feature vectors from received 2D image data, generating a local cluster feature vector by clustering the extracted multi-scale image feature vectors, mapping the local cluster feature vector to a 3D space through an attention operation using a learnable voxel query, decoding a 3D voxel query generated according to the mapping result, and training the 3D voxel query decoder by predicting a 3D occupancy state and a semantic class for a space, based on the decoding result.

Other features and aspects will be apparent from the following detailed description, the drawings, and the claims.

### BRIEF DESCRIPTION OF THE DRAWINGS

FIG. 1 illustrates an example of a three-dimensional (3D) occupancy prediction learning device.

FIG. 2 schematically illustrates an example of a 3D occupancy prediction learning device.

FIG. 3 illustrates an example of region-aware advanced view transform (RAVT).

FIG. 4 schematically illustrates an example of cluster-aware cross-attention.

FIG. 5 schematically illustrates an example of pseudo-two-dimensional (2D) segmentation supervision.

FIG. 6 schematically illustrates 3D context-diversified decoding.

FIGS. 7 and 8 illustrate an example of permutation invariance and consistency normalization, respectively.

FIG. 9 illustrates a block diagram of an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms used herein including technical and scientific terms have the same meanings as those commonly understood by one of ordinary skill in the art to which this disclosure pertains and based on an understanding of the disclosure of the present application. Terms such as those defined in commonly used dictionaries are to be interpreted as having a meaning that is consistent with their meaning in the context of the relevant art and the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The examples may be implemented as various types of products such as, for example, a personal computer (PC), a laptop computer, a tablet computer, a smartphone, a television (TV), a smart home appliance, an intelligent vehicle, a kiosk, a wearable device, and the like. Hereinafter, the examples are described in detail with reference to the accompanying drawings. When describing the examples with reference to the accompanying drawings, like reference numerals refer to like components and a repeated description related thereto is omitted.

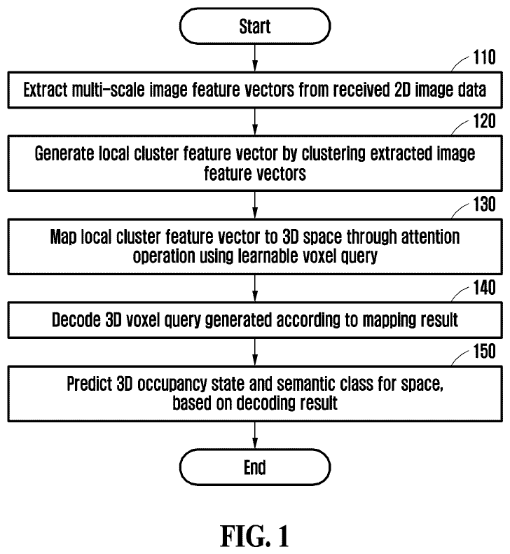

FIG. 1 illustrates an example of a three-dimensional (3D) occupancy prediction learning device.

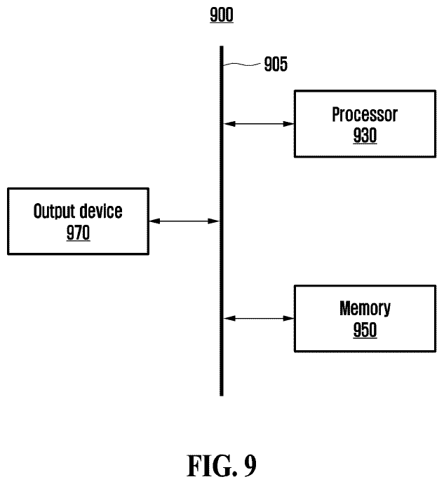

For ease of description, it is described that operations 110 to 150 are performed using an electronic device 900 shown in FIG. 9. However, operations 110 to 150 may be performed by another suitable electronic device in a suitable system.

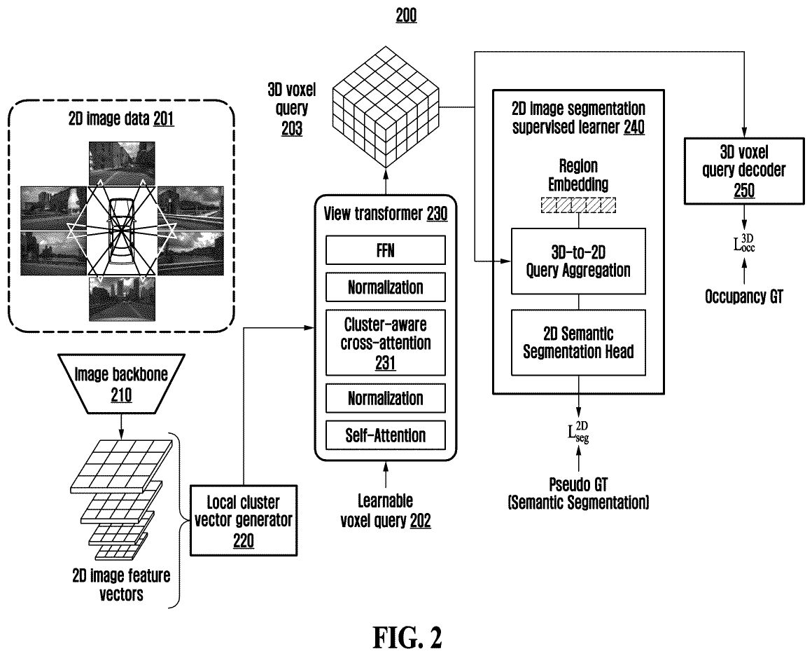

Furthermore, the operations of FIG. 1 may be performed in the shown order and manner. However, the order of some operations may change, or some operations may be omitted without departing from the spirit and scope of the shown example. The operations shown in FIG. 1 may be performed in parallel or simultaneously. The electronic device 900 described below may drive a 3D occupancy prediction learning device 200 shown in FIG. 2. In an example, the electronic device 900 may include the 3D occupancy prediction learning device 200.

Thus, operations 110 to 150 may be described together with reference to FIG. 2.

FIG. 2 schematically illustrates an example of a 3D occupancy prediction learning device.

One or more blocks shown in FIG. 2 or a combination thereof may be implemented by a special-purpose hardware-based computer that performs a predetermined function or a combination of computer instructions and special-purpose hardware.

In operation 110, the electronic device 900 may extract multi-scale image feature vectors from received two-dimensional (2D) image data 201. The 2D image data 201 may be image data obtained from a multi-view camera. An image backbone 210 may extract the multi-scale image feature vectors from the 2D image data 201. The image backbone 210 may extract the multi-scale image feature vectors (e.g., 2D image feature vectors) from the 2D image data 201 in a multi-level manner through a pre-trained convolutional network.

The pre-trained convolutional network may refer to a neural network that has been trained in advance with a large-scale dataset and that may extract an image feature vector from new image data. The multi-view camera may refer to multiple cameras that capture images from different viewpoints. For example, the multi-view camera may be used in an autonomous vehicle to secure a 360-degree view around the vehicle.

In operation 120, the electronic device 900 may generate a local cluster feature vector by clustering the extracted image feature vectors. A local cluster vector generator 220 may group into one cluster and vectorize (e.g., part-level grouping) highly correlated image features among the extracted image features to generate the local cluster feature vector.

Part-level grouping may refer to a method of grouping into a single large feature vector and representing the highly correlated image features among the extracted image features. For example, the electronic device 900 may first divide an entire feature map into a determined grid and may obtain initial-stage cluster information by averaging feature information within the grid. When the initial-stage cluster information is obtained, the electronic device 900 may determine a similarity between the cluster information and each feature vector using a metric such as cosine similarity and may update the existing cluster information using an inner product based on the obtained similarity. The electronic device 900 may update the cluster information by repeating this process multiple times and may thus obtain appropriate cluster information based on a similarity with surrounding information.

For example, image feature vectors may be clustered using the part-level grouping method. For each of a plurality of image features, the local cluster vector generator 220 may analyze a spatial shape of the image feature using a superpixel algorithm and may set a cluster center based on the spatial shape. When the cluster centers are set, a similarity index (e.g., a cosine similarity) between each cluster center and an image feature may be determined, and a final local cluster feature vector may be generated through repeated updates.

In operation 130, the electronic device 900 may map the local cluster feature vector to a 3D space through an attention operation using a learnable voxel query 202. The electronic device 900 may reflect clustered information in a voxel query by performing aggregate and dispatch through an attention operation. The electronic device 900 may generate a 3D voxel query based on a mapping result.

A view transformer 230 may map the local cluster feature vector to the 3D space through the attention operation using the learnable voxel query 202. The attention operation may be performed by cluster-aware cross attention 231. The learnable voxel query 202 may be a data structure for representing each point in the 3D space and may be used to transform local cluster vectors into a 3D voxel format. The cluster-aware cross-attention 231 may perform an operation that aggregates and dispatches a local cluster vector and the learnable voxel query 202. Through this, local cluster vector information may be effectively reflected in the learnable voxel query 202.

The electronic device 900 may train networks for 3D occupancy prediction learning by using a 3D voxel query 203 in 2D image segmentation supervised learning. Here, the electronic device 900 may obtain an encoded 3D voxel query from the 3D voxel query 203 and 2D image feature vectors using a 2D image segmentation supervised learner 240, and may output an attention segmentation map based on a deformable attention map derived from the encoded 3D voxel query. The electronic device 900 may perform contrastive learning using the attention segmentation map and a pseudo mask.

In operation 140, the electronic device 900 may decode the 3D voxel query 203 generated according to the mapping result.

The electronic device 900 may perform voxel upsampling of the 3D voxel query 203 by reflecting permutation invariance of a 3D space. In this case, the electronic device 900 may generate augmented 3D voxel queries by transforming the 3D voxel query into a plurality of viewpoints. The electronic device 900 may apply a consistency regularization technique via a transposed convolutional network to the augmented 3D voxel queries.

In operation 150, the electronic device 900 may predict a 3D occupancy state and a semantic class for a space, based on a decoding result. A 3D voxel query decoder 250 may include a 3D voxel query augmentor.

The 3D voxel query decoder 250 of one or more embodiments may predict a 3D occupancy state based on voxel queries upsampled through the 3D voxel query augmentor and may improve a reliability of the predicted 3D occupancy state through a consistency regularization technique. The 3D voxel query decoder 250 may classify an occupancy state and a semantic class of each voxel using an input voxel query and may generate an occupancy state map for an entire 3D space. In addition, the method and apparatus of one or more embodiments may regularize a predicted semantic class through a semantic class classification network and may provide consistent and reliable 3D spatial information.

The networks may be trained by contrastive learning through the 2D image segmentation supervised learning and result learning according to occupancy state prediction of a 3D voxel query decoder. Referring to FIG. 2, the networks may be the image backbone 210, the local cluster vector generator 220, the view transformer 230, the 2D image segmentation supervised learner 240, and the 3D voxel query decoder 250. The networks may be trained using a backpropagation method, using

$${L}_{s e g}^{2 D} and {L}_{s e g}^{3 D} .$$

For example, the 2D image segmentation supervised learner 240 may train networks by determining a dice loss between actual ground truth (GT) and a 2D image segmentation map predicted using pseudo GT (e.g., semantic segmentation). The 3D voxel query decoder 250 may train the networks by determining a loss between an actual occupancy state and a 3D occupancy state predicted using occupancy GT. Ultimately, these prediction results may be used for environmental perception and path planning of an autonomous driving system.

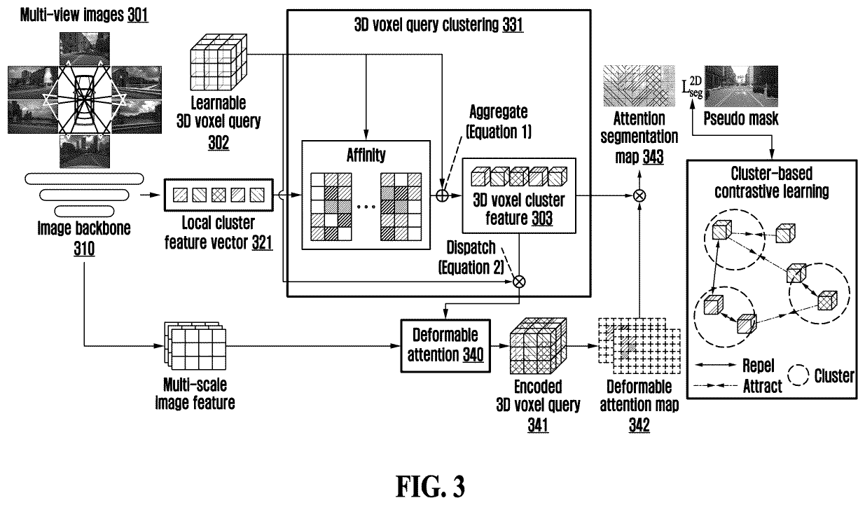

FIG. 3 illustrates an example of region-aware advanced view transform (RAVT).

The description provided with reference to FIGS. 1 and 2 may apply to FIG. 3, and any repeated description related thereto may be omitted.

Referring to FIG. 3, the 3D occupancy prediction learning device 200 may receive N multi-view images 301

$${\{ {I}_{i} \}}_{i = 1}^{N}$$

(e.g., the 2D image data 201 of FIG. 2) and reconstruct a 3D occupancy scene O∈R^{L×H×W×Z} to train networks for 3D occupancy prediction. Here, H, W, and Z denote spatial dimensions, and L denotes a semantic label.

An image backbone 310 (e.g., ResNet50) may extract a multi-scale image feature (e.g., the 2D image feature vectors of FIG. 2)

$${\{ {\{ {F}_{i}^{t} \}}_{i = 1}^{N} \}}_{t = 1}^{T}$$

using a feature pyramid network (FPN). Here, T denotes a total number of different feature scales, and a channel size of each feature may be d.

The local cluster vector generator 220 may generate a local cluster feature vector 321 C_{img}∈R^{N×M×d} from multi-scale image features. Here, M may denote a number of clusters. The local cluster vector generator 220 may repeatedly update the local cluster feature vector 321 C_{img} based on a superpixel algorithm. First, the local cluster vector generator 220 may divide a feature F(0) of a lowest level into regular grids of a r×r size, determine an average value of values within the grids, and set an initial local cluster feature vector based on the determined average value. When the initial local cluster feature vector is set, the local cluster vector generator 220 may determine a similarity index (e.g., a cosine similarity) between the local cluster feature vector 321 C_{img} and the image feature F(0) to measure a soft assignment matrix A∈[0, 1]^{N×M×h′w′}. Here, h′ and w′ may denote a spatial shape of an image feature. During multiple repetitions, the local cluster feature vector 321 C_{img} may be enhanced by multiplying A by F(0). Through this process, the local cluster vector generator 220 may generate the local cluster feature vector 321.

When the local cluster feature vectors 321 are generated, the local cluster feature vectors 321 may be transformed into an integrated 3D voxel cluster feature 303 using a learnable 3D voxel query 302 (e.g., the learnable voxel query 202 of FIG. 2) Q∈ [symbol] ^{h×w×z}. The view transformer 230 may perform 3D voxel query clustering 331 using the cluster-aware cross-attention 231. Here, the cluster-aware cross-attention 231 may perform aggregation (e.g., Equation 1 below) and dispatch (e.g., Equation 2 below). The cluster-aware cross-attention 231 may determine an affinity matrix S∈R^{N×M×K} through a pair-wise cosine similarity between the learnable 3D voxel query 302 Q and the local cluster feature vector 321 C_{img}. Since the local cluster feature vector 321 C_{img} may be in a 2D image space, the cluster-aware cross-attention 231 may project the local cluster feature vector 321 C_{img} into a 3D voxel space using a multi-layer perceptron (MLP) layer. When the local cluster feature vector 321 C_{img} is projected into the 3D voxel space, the cluster-aware cross-attention 231 may structuralize the 3D voxel cluster feature 303 Cᵥₒₓ∈R^{N×M×d} through aggregation. The cluster-aware cross-attention 231 may output the 3D voxel query 203 by dispatching the 3D voxel cluster feature 303 to the learnable 3D voxel query 302.

$$Aggr . {C}_{v o x} = \frac{1}{R} ( {C}_{i m g} + σ ( S ) * Q ) \qquad Equation 1$$

$$Disp . {Q}_{a d v} = Q + M L P ( {σ ( S )}^{T} * {C}_{v o x} ) \qquad Equation 2$$

Here, a sigmoid function σ may scale a similarity to (0, 1) and divide the local cluster feature vector 321 by a total sum of similarities through a regularization constant R to perform stable training. When the stable training is performed, an advanced 3D voxel query Q_{adv} (e.g., the 3D voxel query 203) and a multi-scale image feature F may be used for deformable attention 340. The view transformer 230 may transmit the 3D voxel query 203 including both a high-level clustered visual feature and a fine-grained visual feature to the 3D voxel query decoder 250.

Although the 3D voxel query clustering 331 alone may provide a 2D high-level context, more precise clustering of meaningful features may be performed. Thus, through cluster-based contrastive learning by the 2D image segmentation supervised learner 240, related 3D voxel regions may be separated and selective encoding of correlated image features may be performed.

For the 2D image segmentation supervised learning, a predicted local cluster feature and a corresponding GT mask may be determined. To obtain a predicted cluster feature g E R^{N×c×h′×w′}, the 2D image segmentation supervised learner 240 may map the 3D voxel cluster feature 303 Cᵥₒₓ to each of 2D grid cells that share a same spatial shape with the image feature.

First, the deformable attention 340 may obtain an encoded 3D voxel query 341 using the multi-scale image feature F and the 3D voxel query 203. The 2D image segmentation supervised learner 240 may obtain a 2D grid cell G_{DAM}∈R^{N×M×h′×w′} by utilizing the deformable attention map 342 derived from the encoded 3D voxel query 341. The deformable attention map 342 may highlight notable regions of an image feature across entire regions of each voxel query. Thus, the 2D image segmentation supervised learner 240 may enhance an important feature of the deformable attention map 342 by differently processing each 3D voxel cluster feature 303 Cᵥₒₓ in a predefined grid cell. When the important feature of the deformable attention map 342 is enhanced, the 2D image segmentation supervised learner 240 may group the deformable attention map 342 mapped to the 2D grid cell using the affinity matrix S used in the 3D voxel query clustering 331. Finally, the 3D voxel cluster feature 303 Cᵥₒₓ mapped to the 2D grid cell may be multiplied by the deformable attention map 342 G_{DAM} mapped to the 2D grid cell grouped with the 3D voxel cluster feature 303 Cᵥₒₓ so that the predicted cluster feature g considering the importance of each cluster may be configured. As a result, the 2D image segmentation supervised learner 240 may integrate the deformable attention maps 342 to obtain an attention segmentation map O_{seg} 343.

However, explicit GT for a grouping area may not exist. Thus, a pseudo mask generator may be used, such as a clustering algorithm like SEEDS or a visual basic model like Segment Anything. K pseudo masks that share semantically similar properties may be obtained through the pseudo mask generator. As a result, the 2D image segmentation supervised learner 240 may perform cluster-based contrastive learning such as Equation 3 and/or Equation 4 below, for example, to identify clusters.

$${L}_{2 d} = Dice ( {O}_{s e g} , {GT}_{p s e u d o} ) \qquad Equation 3$$

$${ℒ}_{cls} = - log \frac{{\sum }_{i = 1}^{K} {m}_{i} exp ( {u}_{i} {,}_{:} ⊙ {g}_{:} , {h}^{′} , {w}^{′} / τ )}{{\sum }_{i = 1}^{K} exp ( {u}_{i} {,}_{:} ⊙ {g}_{:} , {h}^{′} , {w}^{′} / τ )} \qquad Equation 4$$

Here, the 2D image segmentation supervised learner 240 may obtain a center feature

$${\{ {u}_{i} \}}_{i = 1}^{K}$$

by determining an average feature within a mask m. ⊙ denotes a similarity operation, and τ denotes temperature.

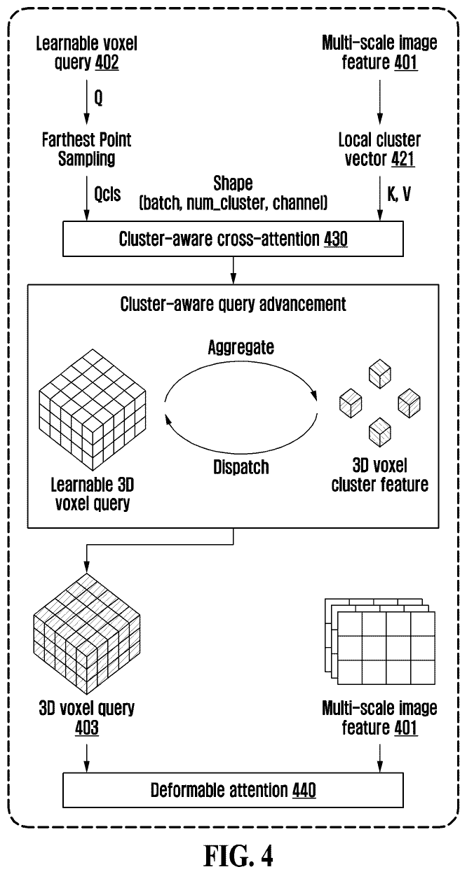

FIG. 4 schematically illustrates an example of cluster-aware cross-attention.

The description provided with reference to FIGS. 1 to 3 may apply to FIG. 4, and any repeated description related thereto may be omitted.

Referring to FIG. 4, cluster-aware cross-attention 430 (e.g., the cluster-aware cross-attention 231 of FIG. 2) may operate by receiving, as an input, a multi-scale image feature 401 (e.g., the 2D image feature of FIG. 2) and a learnable voxel query 402 (e.g., the learnable voxel query 202 of FIG. 2).

The multi-scale image feature 401 may be feature vectors extracted from image data obtained from a multi-view camera via a pre-trained convolutional network. An image feature may exist in various resolutions and sizes, and each image feature vector may represent an image at a different viewpoint. The learnable voxel query 402 may be a data structure for representing each point in a 3D space and may include cluster feature vectors transformed into a voxel format. The learnable voxel query 402 Q may be composed of points selected through Farthest Point Sampling (FPS) and transformed into the learnable voxel query 402 Qcls. FPS is an algorithm for selecting representative points from a set of 3D points and may be used to increase sampling efficiency mostly by ensuring uniform distribution of points. Voxel query points selected through FPS may form representative points evenly distributed in a 3D space.

A local cluster vector 421 generated from the multi-scale image feature 401 through clustering may be expressed in a form of Qcls (e.g., a batch, a num_cluster, or a channel). The local cluster vector 421 may be aggregated with the learnable voxel query 402 Qcls and provide query (Q), key (K), and value (V) values used to perform cross-attention.

The cluster-aware cross-attention 430 may determine a correlation between the query, the key, and the value through cross-attention and may perform cluster-aware query advancement based on the determinion result.

The cluster-aware query advancement may be achieved through aggregate and dispatch. By aggregating the local cluster feature vector 321 as shown in Equation 1 and Equation 2 above, and through dispatch reflecting information of each local cluster in a learnable 3D voxel query, the local cluster feature vector 321 may be transformed into a 3D voxel query 403 (e.g., the 3D voxel query 203 of FIG. 2). The learnable voxel query 402 may reflect an advanced image feature (e.g., an object boundary) based on clustered image information. The cluster-aware cross-attention 430 may learn a correlation between each cluster using the learnable voxel query 402. The cluster-aware cross-attention 430 may perform aggregate and dispatch operations to reflect clustered information in a voxel query included in each cluster.

When the aggregate and dispatch operations are performed, the multi-scale image feature 401 and the 3D voxel query 403 generated through the cluster-aware cross-attention 430 may be input to deformable attention 440 (e.g., the deformable attention 340 of FIG. 3) so that 3D occupancy prediction learning may be performed.

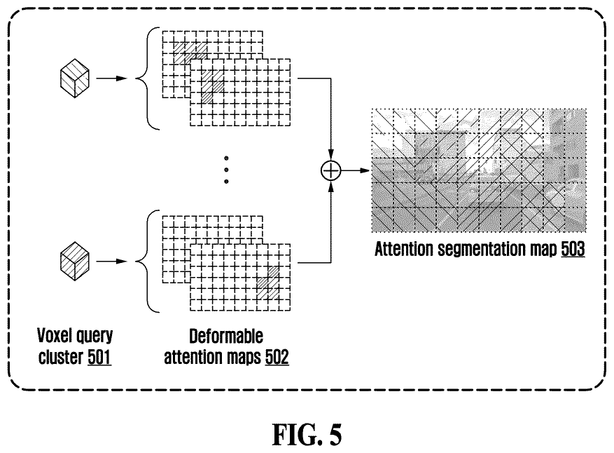

FIG. 5 schematically illustrates an example of pseudo-2D segmentation supervision.

The description provided with reference to FIGS. 1 to 4 may apply to FIG. 5, and any repeated description related thereto may be omitted.

Referring to FIG. 5, a process is illustrated in which the 2D image segmentation supervised learner 240 of one or more embodiments enhances accuracy of 3D space occupancy prediction through a 2D image segmentation map by performing pseudo-2D segmentation supervision, thereby efficiently reducing information of an image space and thus minimizing a loss of information.

A voxel query cluster 501 may be generated by clustering the 3D voxel query 203 output from the cluster-aware cross-attention 231. The deformable attention 340 may determine an attention on information around a reference point corresponding to each voxel query cluster 501 of a multi-scale image feature. The deformable attention 340 may output deformable attention maps 502 (e.g., the deformable attention maps 342) corresponding to each voxel within the voxel query cluster 501 obtained in the process described above.

An attention segmentation map 503 (e.g., the attention segmentation map 343 of FIG. 3) may be generated by aggregating the deformable attention maps 502. The attention segmentation map 503 may show a boundary in an image and include independent information within the boundary, thereby helping enhance the accuracy of 3D space occupancy prediction of the method and apparatus of one or more embodiments.

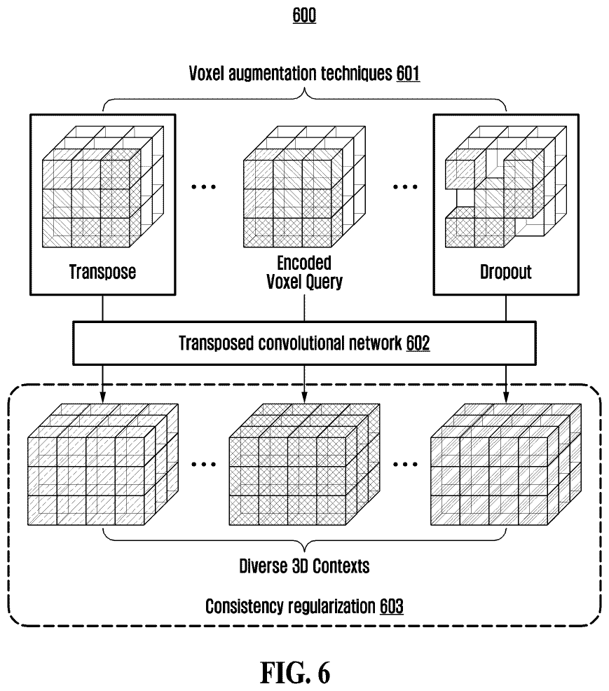

The attention segmentation map 503 may be used to train an entire network through determining a loss function with pseudo GT 505, as described above with reference to FIG. 3. FIG. 6 schematically illustrates 3D context-diversified decoding.

Referring to FIG. 6, an input image of a network may be a projection from a higher dimension (e.g., 3D) to a lower dimension (e.g., 2D). Thus, when reconstructing a 3D scene from a 2D image, geometric ambiguity may occur due to dimensionality reduction. Thus, a single 2D image may potentially be decoded in various 3D contexts. 3D context diversity decoding may implement context diversity by augmenting various 3D voxel queries, and may implement various augmentations representing a same 3D scene by using consistency regularization.

3D voxel query augmentation may generate various 3D contexts from a 3D scene. However, since a grid of each voxel query may recognize a relative position of the grid, augmentation may need to be done to preserve local connectivity within the voxel query grid.

Thus, in the described example, a 3D voxel query may be augmented through two types of voxel augmentation techniques 601.

A 3D voxel query may be augmented through feature-level augmentation (e.g., random dropout and Gaussian noise) and spatial-level augmentation (e.g., transpose and flip). A 3D voxel query augmentor 600 may aggregate 3D voxel queries augmented through the above-described methods to create P different voxel augmentations and obtain a query set Q={Q⁰, Q¹, . . . , Q^{P-1}, Q^{P}}. Here, Q⁰ denotes the original voxel query.

When the P different voxel augmentations are created and the query set Q is obtained, the 3D voxel query augmentor 600 may generate an upsampled grid set V={V⁰, V¹, . . . , V^{P-1}, V^{P}} that maps a final occupancy state of a voxel at a cell position of each grid by passing the query set through a transposed convolutional network 602 having a shared weight. Here, an upsampled spatial resolution may match a spatial resolution of a final occupancy scene O. At each grid cell position, a shared kernel may synthesize features from different local neighbors. As a result, upsampled voxel queries may include features from different contexts of a same scene, achieving context diversity.

An augmented grid set V may need to describe a same semantic occupancy state despite having various pieces of context information. Thus, the 3D voxel query augmentor 600 of one or more embodiments may aggregate the grid set with a regularization loss to maintain a consistent prediction. A consistency regularization 603 may be widely used in semi-supervised learning to process unlabeled data. However, the described example focuses on training a network based on various voxel query representations and may thus be closer to a self-supervised learning framework.

For example, the 3D voxel query augmentor 600 may adopt a regularization technique such as GRAND to minimize a distance between a predicted label distribution and an average distribution of each grid cell. For example, an average of the predicted label distribution at a (h, w, z) position may be

$${\hat{V}}_{h w z} = \frac{1}{P + 1} {\sum }_{p = 0}^{P} f ( {V}_{h w z}^{p} ) .$$

Here, f(⋅) may be a label classification network. Subsequently, this distribution may be expressed as Equation 5 below, for example.

$${\tilde{V}}_{hwz} [ k ] = {\hat{V}}_{hwz}^{\frac{1}{T}} [ k ] / {\sum }_{l = 1}^{L} {\hat{V}}_{hwz}^{\frac{1}{T}} [ l ] , ( 1 \leq k \leq L ) \qquad Equation 5$$

Here, k denotes an estimated probability for a k-th class, and T denotes a temperature hyperparameter that controls a sharpness of a distribution of a category. Thus, a final consistency regularization loss may be determined by taking an average sharpened over all grid cells and augmentations and an average of distances between each prediction, as in Equation 6 below, for example.

$${ℒ}_{cons} = \frac{1}{H \cdot W \cdot Z \cdot ( P + 1 )} {\sum }_{p = 0}^{P} {\sum }_{z = 1}^{Z} {\sum }_{w = 1}^{W} {\sum }_{h = 1}^{H} {‖ {\tilde{V}}_{hwz} - f ( {V}_{hwz}^{( p )} ) ‖}_{2}^{2} \qquad Equation 6$$

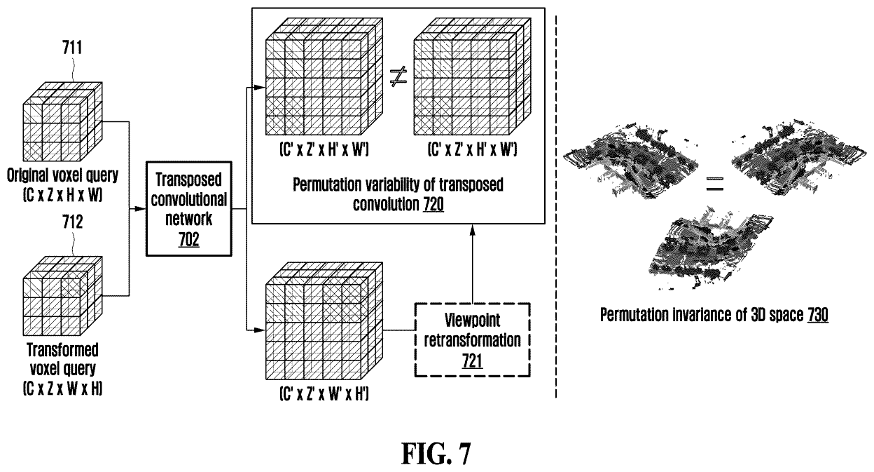

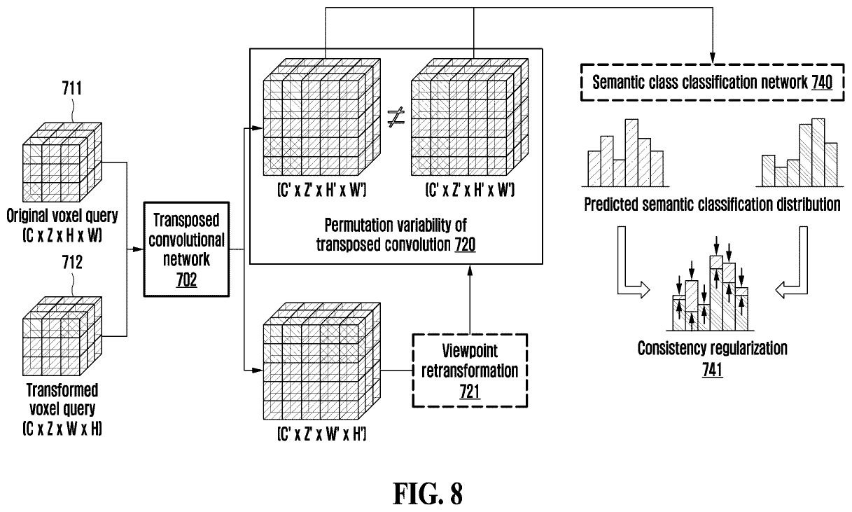

FIGS. 7 and 8 illustrate an example of permutation invariance and consistency normalization, respectively.

The description provided with reference to FIGS. 1 to 6 may apply to FIGS. 7 and 8, and any repeated description related thereto may be omitted.

Referring to FIG. 7, a 3D voxel query (e.g., the 3D voxel query 203 of FIG. 2) may be upsampled through a transposed convolutional network 702 and transformed to various viewpoints. A voxel query may include an original voxel query 711 and a transformed voxel query 712. As may be confirmed from a permutation variability 720 of a transposed convolution, even when matching a viewpoint of a voxel query with only H and W changed through viewpoint retransformation 721, the transposed convolutional network 702 may produce a different result according to a spatial configuration of the voxel. However, as may be confirmed from a permutation invariance 730 of a 3D space, an essential occupancy state of a 3D space may not change depending on a viewing angle. That is, even when a 3D voxel query is output from same 2D image feature data, information loss may occur due to information compression, and accordingly, a different result may be produced when viewpoints are matched.

Referring to FIG. 8, consistency regularization 741 may be performed so that voxel queries upsampled through the transposed convolutional network 702 may represent a same 3D scene through the viewpoint retransformation 721. The consistency regularization 741 may be a process of regularizing to maintain consistency of a predicted semantic class classification distribution. The 3D voxel query augmentor 600 of one or more embodiments may regularize the predicted semantic classification distribution through a semantic class classification network 740 to ensure a consistency of results.

That is, by transforming a 3D voxel query into various viewpoints and applying consistency regularization 741 so that result distributions of voxel queries that have passed through the same transposed convolutional network may become similar, the method and apparatus of one or more embodiments may perform robust decoding of a query with over-compressed information.

FIG. 9 illustrates a block diagram of an example of an electronic device.

Referring to FIG. 9, the electronic device 900 (e.g., an autonomous vehicle or a server) may include a processor 930 (e.g., one or more processors), a memory 950 (e.g., one or more memories), and an output device 970 (e.g., a display). The processor 930, the memory 950, and the output device 970 may be connected to one another through a communication bus 905. In the process described above, for ease of description, the electronic device 900 may include the processor 930 for performing at least one method described above or an algorithm corresponding to at least one method described above.

The output device 970 may display a user interface related to 3D occupancy prediction learning provided by the processor 930.

The memory 950 may store data obtained in relation to 3D occupancy prediction learning performed by the processor 930. Furthermore, the memory 950 may store a variety of information generated in the processing process of the processor 930 described above. In addition, the memory 950 may store a variety of data and programs. The memory 950 may include, for example, a volatile memory or a non-volatile memory. The memory 950 may include a high-capacity storage medium such as a hard disk to store a variety of data.

In addition, the processor 930 may perform at least one of the methods described with reference to FIGS. 1 to 8 or an algorithm corresponding to at least one of the methods. The processor 930 may be a data processing device implemented by hardware including a circuit having a physical structure to perform desired operations. The desired operations may include, for example, instructions or code in a program. The processor 930 may be implemented as, for example, a central processing unit (CPU), a graphics processing unit (GPU), or a neural network processing unit (NPU). For example, a hardware-implemented electronic device 900 may include, for example, a microprocessor, a CPU, a processor core, a multi-core processor, a multiprocessor, an application-specific integrated circuit (ASIC), and a field programmable gate array (FPGA).

The processor 930 may execute a program and control the electronic device 900. Program code to be executed by the processor 930 may be stored in the memory 950. For example, the memory 950 may include a non-transitory computer-readable storage medium storing instructions that, when executed by the processor 930, configure the processor 930 to perform any one, any combination, or all of the operations and methods described herein with reference to FIGS. 1-8.

The training process and operation algorithms described above may be executed on a server and applied to an autonomous vehicle or performed within the autonomous vehicle.

For example, the server may receive 2D image data from an autonomous vehicle and utilize the 2D image data for learning or may utilize learning image data for learning.

In another example, an autonomous vehicle may include an electronic device and a processor for 3D occupancy prediction learning, wherein the processor may receive 2D image data from a camera of the autonomous vehicle to perform 3D occupancy prediction learning or may perform 3D occupancy prediction learning from existing image data.

The 3D occupancy prediction learning devices, image backbones, local cluster vector generators, view transformers, 2D image segmentation supervised learners, 3D voxel query decoders, 3D voxel query augmentors, electronic devices, processors, memories, output devices, communication buses, 3D occupancy prediction learning device 200, image backbone 210, local cluster vector generator 220, view transformer 230, 2D image segmentation supervised learner 240, 3D voxel query decoder 250, 3D voxel query augmentor 600, electronic device 900, processor 930, memory 950, output device 970, and communication bus 905 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with three-dimensional (3D) occupancy prediction learning, the method comprising:
extracting multi-scale image feature vectors from received two-dimensional (2D) image data;
generating a local cluster feature vector by clustering the extracted multi-scale image feature vectors;
mapping the local cluster feature vector to a 3D space through an attention operation using a learnable voxel query;
decoding a 3D voxel query generated according to the mapping result; and
predicting a 3D occupancy state and a semantic class for a space, based on the decoding result.

2. The method of claim 1, wherein the attention operation reflects clustered information in the learnable voxel query by performing aggregate and dispatch.

3. The method of claim 1, further comprising training networks for 3D occupancy prediction learning by using the 3D voxel query in 2D image segmentation supervised learning.

4. The method of claim 3, wherein the training of the networks comprises:
obtaining an encoded 3D voxel query from the 3D voxel query and the extracted multi-scale image feature vectors; and
outputting an attention segmentation map based on a deformable attention map derived from the encoded 3D voxel query.

5. The method of claim 4, further comprising performing contrastive learning using the attention segmentation map and a pseudo mask.

6. The method of claim 1, wherein the decoding of the 3D voxel query comprises performing voxel upsampling of the 3D voxel query by reflecting permutation invariance of a 3D space.

7. The method of claim 6, wherein the performing of the voxel upsampling comprises generating augmented 3D voxel queries by transforming the 3D voxel query into a plurality of viewpoints.

8. The method of claim 7, further comprising applying a consistency regularization technique via a transposed convolutional network to the augmented 3D voxel queries.

9. The method of claim 1, wherein the 2D image data comprises image data obtained from a multi-view camera.

10. A non-transitory computer-readable storage medium storing instructions that, when executed by one or more processors, configure the one or more processors to perform the method of claim 1.

11. An electronic device comprising:
one or more processors configured to:
extract multi-scale image feature vectors from received two-dimensional (2D) image data;
generate a local cluster feature vector by clustering the extracted multi-scale image feature vectors;
map the local cluster feature vector to a three-dimensional (3D) space through an attention operation using a learnable voxel query;
decode a 3D voxel query generated according to the mapping result; and
predict a 3D occupancy state and a semantic class for a space, based on the decoding result.

12. The electronic device of claim 11, wherein the attention operation reflects clustered information in the learnable voxel query by performing aggregate and dispatch.

13. The electronic device of claim 11, wherein the one or more processors are configured to train networks for 3D occupancy prediction learning by using the 3D voxel query in 2D image segmentation supervised learning.

14. The electronic device of claim 13, wherein, for the training of the networks, the one or more processors are configured to:
obtain an encoded 3D voxel query from the 3D voxel query and the extracted multi-scale image feature vectors; and
output an attention segmentation map based on a deformable attention map derived from the encoded 3D voxel query.

15. The electronic device of claim 14, wherein the one or more processors are configured to perform contrastive learning using the attention segmentation map and a pseudo mask.

16. The electronic device of claim 11, wherein, for the decoding of the 3D voxel query, the one or more processors are configured to perform voxel upsampling of the 3D voxel query by reflecting permutation invariance of a 3D space.

17. The electronic device of claim 16, wherein, for the performing of the voxel upsampling, the one or more processors are configured to generate augmented 3D voxel queries by transforming the 3D voxel query into a plurality of viewpoints.

18. The electronic device of claim 17, wherein the one or more processors are configured to apply a consistency regularization technique via a transposed convolutional network to the augmented 3D voxel queries.

19. The electronic device of claim 11, wherein the 2D image data comprises image data obtained from a multi-view camera.

20. A vehicle comprising:
one or more processors configured to:
drive a three-dimensional (3D) voxel query decoder trained in a 3D occupancy prediction learning process; and
drive a 3D voxel decoder configured to predict a 3D occupancy state and a semantic class for a space from a two-dimensional (2D) image received from a camera included in the vehicle,
wherein the training of the 3D voxel query decoder in the 3D occupancy prediction learning process comprises:
extracting multi-scale image feature vectors from received 2D image data;
generating a local cluster feature vector by clustering the extracted multi-scale image feature vectors;
mapping the local cluster feature vector to a 3D space through an attention operation using a learnable voxel query;
decoding a 3D voxel query generated according to the mapping result; and
training the 3D voxel query decoder by predicting a 3D occupancy state and a semantic class for a space, based on the decoding result.
